(19) United States
(12) Patent Application Publication
(10) Pub. No.: US 2011/0022329 A1
(43) Pub. Date: Jan. 27, 2011

(54) Method and Apparatus For Determining Seed Germination

(75) Inventors: Ching-Hui Tseng, West Chester, OH (US); Barbara Stefl, Lebanon, OH (US)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/933,508

(22) PCT Filed: Mar. 14, 2009
(86) PCT No.: PCT/EP09/01876

§ 371 Date: Sep. 20, 2010

Related U.S. Application Data
(60) Provisional application No. 61/039,282, filed on Mar. 25, 2008.

(51) Int. Cl. G06F 19/00; A01C 1/02; G06F 17/10; G01J 3/28

(52) U.S. Cl. 702/19; 356/326; 703/2

(57) ABSTRACT

A method is provided for determining the rate of seed germination including the steps of (a) irradiating a selected number or quantity of seeds with light from an NIR spectrometer which is combined with or coupled to a pre-defined calibration model, wherein the light reflects to a detector; (b) collecting the reflected light from the detector; (c) converting the reflected light to an NIR spectrum; and (d) determining the rate of germination using the NIR spectrum obtained and the calibration model. Also provided is a cup for use with an NIR spectrometer including a rotating cylindrical member for receiving a selected number or quantity of seeds coupled to a transparent base through which NIR light is irradiated.

### BACKGROUND OF THE INVENTION

1. Field of the Invention

The invention relates generally to germination tests for seeds, and more particularly, to a method and apparatus for determining and predicting the rate of seed germination using near-infrared spectroscopy.

2. Background Information

Germination tests are currently used to identify the quality of seeds planted in warm weather (“warm” or “standard” germination test) and the quality of seeds planted in cool weather (cool germination test). One current warm germination test takes at least nine days, and one cool germination test takes seven days. The testing procedure is lengthy, and destructive, and there are variations in the testing methods employed.

Methods for analyzing grain and other agricultural products may include the use of analytical instruments, including near-infrared spectoscopy (NIR), mid-infrared, and Raman spectrometers. NIR may be used to detect chemical and physical properties, and provides an accurate and inexpensive method for analysis. A calibration model may be coupled with an analytical instrument to generate a result, for example, in monitoring chemical reactions. The monitoring capability may involve the generation of results from the analytical technique, with the application of statistical analysis and calibration models to interpret and quantify the data. For example, in the manufacture of carboxylic acids and derivatives from fats and oils, near-infrared spectrometers which include pre-defined calibration models may be used to measure certain properties of the carboxylic acids and their derivatives.

The mathematical relationship between the instrument response and the property of interest, with respect to a selected material, is referred to as a calibration model. To develop a calibration model, the analytical instrument, which employs a particular analytical method, is trained to measure a property of interest through development of the mathematical relationship between the instrument response and the known values of a material. Experimental data related to the property of interest of a material is generated by recording values relating to the property of interest as determined by a reliable, independent method, on a group of samples. The recorded values are referred to as “known” values. It should be understood that the experimentally determined values of the known data are characterized by experimental uncertainties, so the “known” values are not “known” to be entirely accurate.

The group, or set, of samples of a material with known values of a property of interest used to develop the calibration model is referred to as a calibration set. Variations in the characteristics of the material that are expected to be present in the samples that will be analyzed in the future should be represented by samples in the calibration set, if possible. The calibration set, or more typically a subset thereof, is used to generate a collection of instrument responses over a range of measurement conditions for evaluating a property of interest. The collection of known values and instrument responses generated from the calibration set over a range of measurement conditions is a data set referred to as a training set. Because each sample in the calibration set may be subjected to a range of conditions involving a number of secondary variables, as well as repeated measurements under the same conditions, the training set may contain more numbers than the number of samples comprising the calibration set. A training set generally encompasses both variations in a range of material characteristics and variations in a range of measurement conditions that are expected to be present during actual on-site analyses.

There remains a need for analytical methods for determining the germination of seeds that can effectively replace conventional testing methods.

### SUMMARY OF THE INVENTION

Briefly described, according to an aspect of the invention, a method for determining the rate of seed germination includes the steps of: irradiating a selected number or quantity of seeds with light from an NIR spectrometer which is combined with or coupled to a pre-defined calibration model, wherein the light reflects to a detector; collecting the reflected light from the detector; converting the reflected light to an NIR spectrum; and determining the rate of germination using the NIR spectrum obtained and the calibration model.

According to another aspect of the invention, a cup for use with an NIR spectrometer includes a rotating cylindrical member for receiving a selected number or quantity of seeds coupled to a transparent base through which NIR light is irradiated.

### BRIEF DESCRIPTION OF THE DRAWINGS

FIG. 1 illustrates the sampling device rotatable cup according to an aspect of the invention;

FIG. 2 illustrates a cottonseed cool germination model according to an aspect of the invention;

FIG. 3 illustrates a cottonseed warm germination model according to an aspect of the invention; and

FIG. 4 illustrates a corn cool germination model according to an aspect of the invention.

### DETAILED DESCRIPTION OF THE INVENTION

As used herein, the terms “comprises”, “comprising”, “includes”, “including”, “has”, “having”, or any other variation thereof, mean that other elements or components may be included. For example, a process, method, article, or apparatus that comprises a list of elements is not necessarily limited to the expressly listed elements, but may include other elements inherent, or not expressly listed, to such process, method, article, or apparatus. In addition, unless expressly stated to the contrary, the term “or” refers to an inclusive “or” and not to an exclusive “or”. For example, the condition A “or” B is satisfied by any one of the following: A is true (included) and B is false (omitted); A is false (omitted) and B is true (included); and both A and B are true (both included).

The terms “a” or “an” as used herein are to describe elements and components of the invention. This is done for convenience to the reader and to provide a general sense of the invention. The use of “a” or “an” should be understood to include one or at least one. In addition, the singular also includes the plural, unless indicated to the contrary. For example, reference to a composition containing “a compound” includes at least one or more compounds.

According to an aspect of the invention, a Fourier-Transform Near Infrared (FT-NIR) spectrometer is used. It should be understood that other suitable NIR instruments may also be used to practice the invention. According to an aspect of the invention, the calibration model for evaluating the germination of the seeds was derived using Bruker's OPUS Quant-2 software.

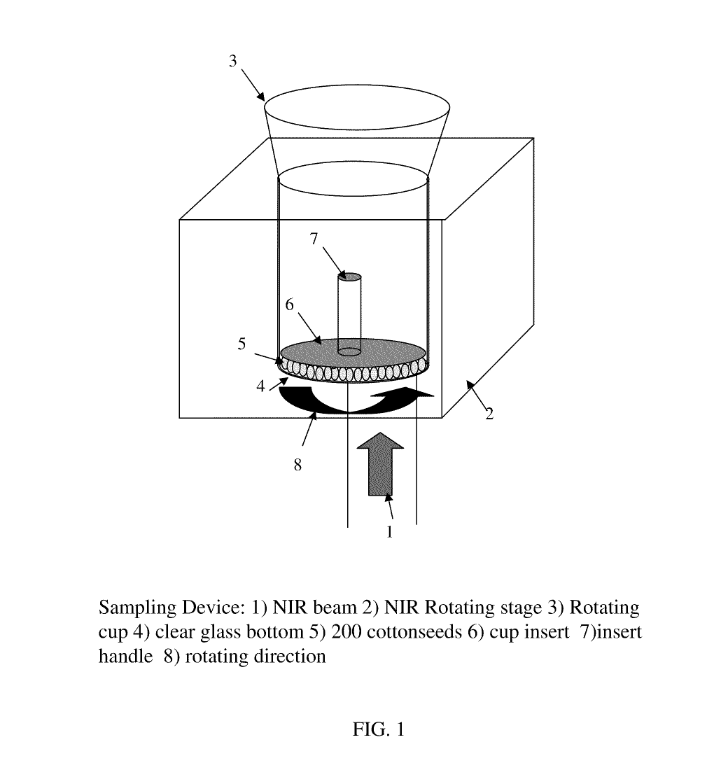

One primary germination test according to an aspect of the invention uses 200 seeds for operation. The seeds are placed in a sampling device described below with respect to FIG. 1.

Referring to FIG. 1, 200 seeds 5 are seated at the bottom 4 of a rotating cup 3. An NIR beam 1 illuminates the seeds 5 through the clear glass bottom 4 of the cup 3. The cup 3 includes a plate 6 coupled to a handle 7, each of which are composed of a metal with a finished surface to reflect the NIR light back to the sample again, and then to the detector of the NIR instrument. The cup may be composed of any suitable plastic, or may be formed from metal. The plate may be composed of aluminum, but any suitable metal that can reflect light in the NIR spectrum may be used. The cup 3 may be about 10 centimeters in diameter, about 10 centimeters high, and the thickness of the glass bottom 4 may be about 1 millimeter. A motor is coupled to the cup (disposed on a metal ring), which rotates the cup 3 on an NIR rotating stage 2 in the direction of arrow 8, so that all of the seed samples are irradiated with the NIR beam, without any gaps between the seeds.

According to an aspect of the invention, the seeds 5 in the cup 3 are irradiated through the clear glass bottom 4 with near-infrared light (about 20 millimeters). The light is absorbed for about 2 to 3 millimeters, and reflected back. Some of the light is reflected off the seeds and collected in an integration sphere (not-shown), which refocuses the light to a detector in the NIR instrument. The absorbed and reflected radiation is detected from the spectral range from 4000 to 12000 wavenumber (cm₋₁) in the NIR spectrum to obtain raw reflectance data of the seeds. The collected light is then converted to an NIR spectra.

The metal plate insert 6 is needed to allow the light to be reflected, due to spaces between the seeds. In some cases, there may be a sufficient amount of a sample, and because all of the light will be reflected back, the insert is not needed.

In developing the calibration models, each sample of seeds is tested under different conditions, i.e., warm or cold germination conditions, and measured multiple times. For example, a calibration set may include 30 samples, for which 150 spectra will be provided.

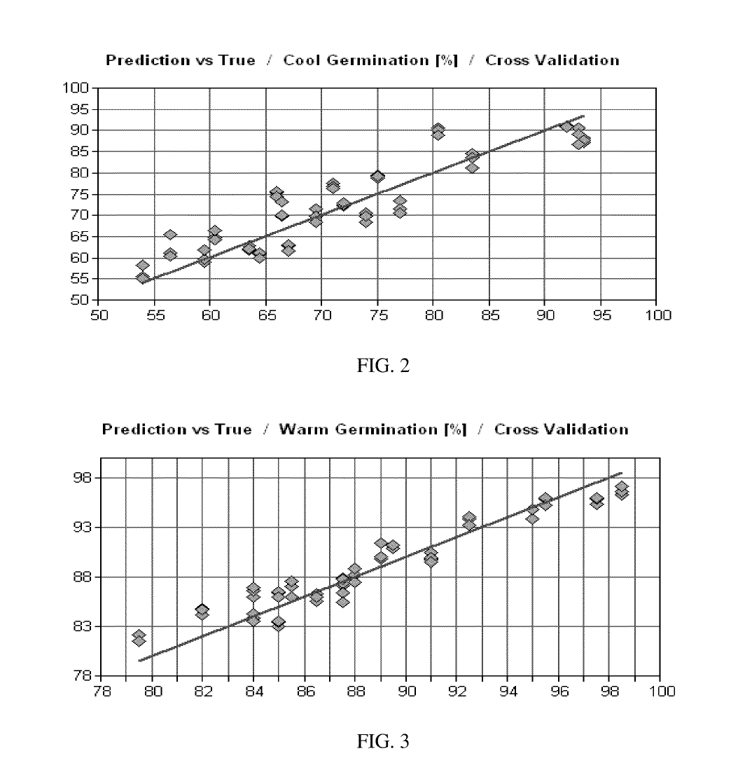

A training set may cover a wide range, i.e., 10% to 100% of the rate of germination. The NIR spectrum obtained and the rate of germination will become a correlation, from which a curve is generated, i.e., NIR vs. rate of germination, where the Y axis is the NIR prediction and the X axis is the primary data, as illustrated in FIGS. 2 and 3.

The spectra were collected with the spectral range from 4000 to 12000 cm⁻¹ and the spectral resolution of 8 cm⁻¹. A set of samples with 200 seeds per sample covering a wide germination range was used as the calibration sample set. After obtaining the NIR spectra of the calibration samples, the seeds were analyzed with the warm and cool germination tests to obtain the primary germination data. The partial least squares (PLS) modeling method was then used to build the correlation between the NIR spectra and the primary data. It should be understood that although PLS was used, other suitable mathematical methods may also be used.

In this invention, a warm germination model and a cool germination model were built with clear correlation for different kinds of seeds, including cottonseed and corn, for example. The models can then be used to predict the NIR spectra of unknown seed samples and to generate the warm and cool germination results.

Advantageously, when an unknown sample is obtained, the sample may be measured to obtain an NIR spectra, from which the rate of germination can be predicted using the model developed according to an aspect of the invention. It should be understood that although cottonseed and corn are exemplified, the rate of germination of any seed can be predicted using the method and apparatus of the invention. In addition, because an NIR beam illuminates the sample, it is non-destructive and the entire process can be finished in minutes or several seconds.

The 200 seed count was necessary only during the development of the method to obtain representative primary data. Once the method is developed, it is not necessary to count the seeds, but the sample amount has to be over one quarter volume of the sampling cup (approximately 100 to 400 grams). A tumbling device as described in U.S. Pat. No. 6,872,946, the entire disclosure of which is hereby incorporated herein, is then used to obtain representative sample spectra for a larger amount of sample and the cup insert described in FIG. 1 is no longer required.

It was found in this invention that NIR spectra shows a clear correlation with both warm and cool germination data using the PLS modeling technique, and a fast and non-destructive germination test method and apparatus was developed.

Unless otherwise defined, all technical and scientific terms used herein have the same meaning commonly understood by one of ordinary skill in the art to which the invention belongs. Although methods and materials similar or equivalent to those described herein can be used in the practice or testing of the invention, suitable methods and materials are described below. The materials, methods and examples are illustrative only, and are not intended to be limiting.

### EXAMPLES

### Example 1

A set of 20 cottonseed samples covering the cool germination range from 54.0 to 93.5% and the warm germination range from 79.5 to 98.5% was used for the correlation investigation. Each sample was measured in triplicate by Cognis Corporation's QTA® UM (modified from Bruker Matrix-1) FT-NIR instrument. The cross validation model of the cool germination with 3 spectra (or one sample) crossed out shows the R² (coefficient of determination) of 0.82 with the RMSECV (root mean squared error of cross validation) of 5%. The plot of NIR prediction vs. cool germination test result is shown as FIG. 2. The cross validation model of the warm germination test shows the R² of 0.91 with the RMSECV of 1.5%. The plot of NIR prediction vs. cool germination test result is shown as FIG. 3.

### Example 2

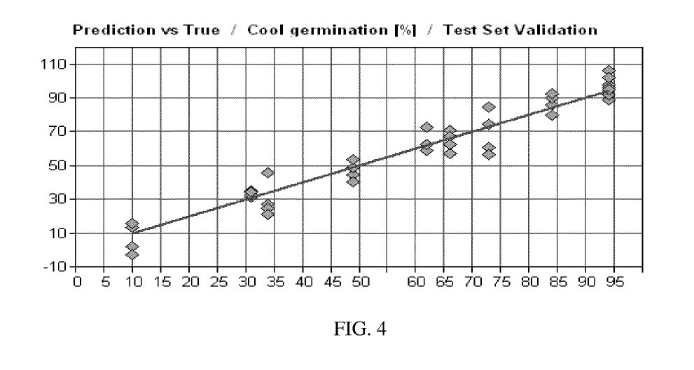

A set of 20 pesticide treated corn seed samples covering the cool germination range from 10 to 94% was used to build a calibration model. Each sample was measured 4 times by the QTA UM FT-NIR instrument. This model was used to validate 10 pesticide treated corn samples not included in the calibration set. The validation result shows the R² of 0.90 with the RMSEP (root mean squared error of prediction) of 8%. The plot of NIR prediction vs. cool germination test result is shown as FIG. 4.

As illustrated in FIGS. 2-4, a fast and non-destructive primary germination test method according to an aspect of the invention provides a clear correlation and an improved method for determining the rate of germination, compared to the germination tests currently available.

The invention has been described with reference to specific embodiments. One of ordinary skill in the art, however, appreciates that various modifications and changes can be made without departing from the scope of the invention as set forth in the claims. Accordingly, the specification is to be regarded in an illustrative manner, rather than with a restrictive view, and all such modifications are intended to be included within the scope of the invention.

The benefits, advantages, and solutions to problems have been described above with regard to specific embodiments. The benefits, advantages, and solutions to problems and any element(s) that may cause any benefit, advantage, or solution to occur or become more pronounced are not to be construed as a critical, required, or essential feature or element of any or all of the claims.

What is claimed is:

1. A method for determining the rate of seed germination, comprising the steps of:
(a) irradiating a selected number or quantity of seeds with light from an NIR spectrometer which is combined with or coupled to a pre-defined calibration model, wherein the light reflects to a detector;
(b) collecting the reflected light from the detector;
(c) converting the reflected light to an NIR spectrum; and
(d) determining the rate of germination using the NIR spectrum obtained and the calibration model.

2. The method according to claim 1, wherein the seeds are placed in a rotatable cup adapted for receiving a selected number of seeds and the cup is rotated for receiving NIR light.

3. The method according to claim 1, wherein the seeds are subjected to a cool germination test.

4. The method according to claim 1, wherein the seeds are subjected to a warm germination test.

5. The method according to claim 1, wherein the selected number of seeds is 200.

6. The method according to claim 1, wherein the selected quantity of seeds is from about 100 to about 400 grams.

7. The method according to claim 1, wherein the calibration model comprises a partial least squares model.

8. A cup for use with an NIR spectrometer, comprising a rotating cylindrical member for receiving a selected number or quantity of seeds coupled to a transparent base through which NIR light is irradiated.

9. The cup according to claim 8, wherein the cylindrical member comprises a plastic or metal material, and the base comprises clear glass.

10. The cup according to claim 8, wherein the selected number of seeds is 200.

11. The cup according to claim 8, wherein the selected quantity of seeds is from about 100 to about 400 grams.
